(19) United States
(12) Patent Application Publication
(10) Pub. No.: US 2009/0008951 A1
(43) Pub. Date: Jan. 8, 2009

(54) Protective bumper adapted for minimizing damage to materials carried by a materials handling vehicle

(75) Inventors: Robert D. Whetstine, Charlotte, NC (US); Eric O. Swanson, Tega Cay, SC (US)

Correspondence Address: Schwartz Law Firm, P.C.;SouthPark Towers, Suite 1135, 6100 Fairview Road, Charlotte, NC, 28210, US

(73) Assignee: Robert D. Whetstine

(21) Appl. No.: 12/217,219

(22) Filed: Jul. 2, 2008

Related U.S. Application Data
(63) Continuation of application No. 11/197,397, filed on Aug. 5, 2005, now abandoned.

(51) Int. Cl. B66F 9/075; B60R 19/03; B60R 19/02

(52) U.S. Cl. 293/120; 187/222

(57) ABSTRACT

A materials handling vehicle incorporates a mechanical lift including a horizontal extension and a vertical back. The vehicle has a protective bumper designed for engaging and protecting materials carried by the vehicle. The protective bumper includes a base located on the vertical back of the lift. A compressible, resilient body is located adjacent the base, and is adapted for absorbing impact of materials loaded onto the lift.

### TECHNICAL FIELD AND BACKGROUND OF THE INVENTION

This application relates to a protective bumper adapted for engaging and protecting materials carried by a materials handling vehicle, such as those utilizing a mechanical forklift. The invention is designed to protect materials from damage resulting from impact against the fork backrest. In many cases, even slight to moderate damage to fragile edges may render the entire product commercially unsaleable.

Forklift damage to materials in industrial warehouses and home improvement stores is substantial—estimated to be in the millions of dollars each year. In most home improvement stores, forklift operators have relatively little experience or formal training in the operation and maneuvering of lift trucks. When approaching a loaded pallet for transport, an operator will typically move the truck forward until the forks have clearly and firmly impacted the materials. While this ensures full extension of the fork tines into the pallet, the impact often damages the materials.

One prior art solution to this problem is to locate an impact sensor on the forkback of the lift truck. If the fork is bumped beyond the selected impact level, the sensor sounds an internal audible alarm. The sensor is intended to limit careless operation of the lift truck and create a safer, more efficient and productive work environment. A significant disadvantage of this attempted solution is that after the impact is made and the alarm sounds the materials damage has already occurred. Another solution is to provide better training and orientation programs for the vehicle operators. However, even for those most qualified operators, unavoidable circumstances and accidents will nevertheless occur in a certain percentage of runs.

### SUMMARY OF INVENTION

Therefore, it is an object of the invention to provide a protective bumper adapted for engaging and protecting materials carried by a materials handling vehicle, thereby reducing materials damage and costs.

It is another object of the invention to provide a protective bumper which does not interfere with the operator's line of sight.

It is another object of the invention to provide a protective bumper which is designed for mounting in only one predetermined location on the lift fork, thereby ensuring proper and effective protection against damage to materials.

It is another object of the invention to provide protective bumper which does not interfere with fork adjustment.

It is another object of the invention to provide protective bumper which is exchangeable and replaceable.

It is another object of the invention to provide a method for protecting materials, such as wallboard, sheet rock, sheet metals, tile board, paneling, foam products, finished woods, acoustical materials, glass and other fragile items commonly carried on lift trucks.

It is another object of the invention to provide an improved materials handling vehicle which incorporates a protective bumper designed for engaging and protecting materials carried by the vehicle.

These and other objects of the present invention are achieved in the preferred embodiments disclosed below by providing an improved materials handling vehicle. The vehicle has a mechanical lift including a horizontal extension and a vertical back. The improvement relates to a protective bumper designed for engaging and protecting materials carried by the vehicle. The protective bumper comprises a base located on the vertical back of the lift. A compressible, resilient body is located adjacent the base, and is adapted for absorbing impact of materials loaded onto the lift. The base and body may be integrally formed together as a single unit, or formed separately of the same or different materials.

According to another preferred embodiment, the protective bumper further includes a flexible outer shell covering the resilient body.

According to another preferred embodiment, the outer shell of the protective bumper is constructed of polyethylene.

According to another preferred embodiment, a mounting panel is fixedly attached to the back of the lift. The mounting panel engages the base of the protective bumper.

According to another preferred embodiment, the mounting panel has opposing longitudinal side tracks. The side tracks are preferably integrally formed with the panel.

According to another preferred embodiment, the base of the protective bumper has opposing longitudinal side edges adapted for being slidably received within respective tracks of the mounting panel.

According to another preferred embodiment, the mounting panel has an end stop adapted for limiting downward sliding movement of the protective bumper.

According to another preferred embodiment, opposing longitudinal compression pleats are formed with respective sides of the resilient body of the protective bumper.

According to another preferred embodiment, opposing lateral compression pleats are formed with respective ends of the resilient body of the protective bumper.

According to another preferred embodiment, the resilient body of the protective bumper is constructed of a polymer foam.

According to another preferred embodiment, the resilient body of the protective bumper has a generally uniform thickness ranging from 1 to 3 inches.

According to another preferred embodiment, the lift comprises a pair of laterally spaced horizontal fork tines, respective integrally-formed elbows, and respective integrally-formed vertical fork backs.

According to another preferred embodiment, the protective bumper is vertically spaced-apart from the horizontal extension, thereby defining a bumper clearance sufficient to accommodate a materials support platform between the horizontal extension and the protective bumper.

In another embodiment, the invention is a protective bumper designed for engaging and protecting materials carried by a materials handling vehicle. The protective bumper has a base located on the vertical back of the lift. A compressible, resilient body is located adjacent the base, and is adapted for absorbing impact of materials loaded onto the lift. At least one compression pleat is formed with the resilient body.

In another embodiment, the invention is a method for minimizing damage to materials carried on a mechanical lift of a materials handling vehicle. The mechanical lift includes a horizontal extension and a vertical back. The method includes the step of locating a protective bumper adjacent the vertical back, and a spaced distance above the horizontal extension of the mechanical lift. The spaced distance defines a bumper clearance sufficient to accommodate a materials support platform.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of an improved materials handling vehicle incorporating protective bumpers according to one preferred embodiment of the present invention;

FIG. 1A is an enlarged view of the protective bumper located on the fork backrest;

FIG. 2 shows the mounting panel separated from the fork backrest, and the protective bumper in position for being slidably received into the side tracks of the mounting panel;

FIG. 3 is a cross-sectional view taken substantially along line 3-3 of FIG. 2;

FIG. 3A is an enlarged cross-sectional view demonstrating operation of the protective pad upon impact by a force indicated at “F”;

FIG. 4 is a cross-sectional view taken substantially along line 4-4 of FIG. 2; and

FIG. 5 is a cross-sectional view of the protective bumper taken substantially along line 5-5 of FIG. 2.

### DESCRIPTION OF THE PREFERRED EMBODIMENT AND BEST MODE

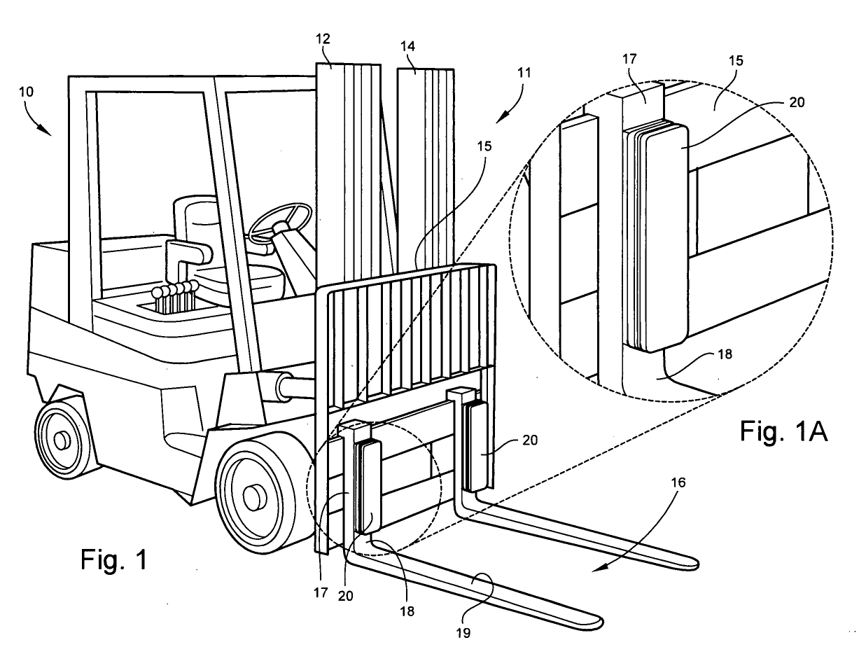

Referring now specifically to the drawings, a materials handling vehicle according to the present invention is illustrated in FIG. 1, and shown generally at reference numeral 10. The vehicle 10 incorporates a conventional mechanical lift 11 comprising spaced vertical masts 12 and 14, a carriage 15 designed for upward and downward movement along the masts 12, 14, and a pair of forks 16. Each fork 16 has an integrally-formed vertical backrest 17, elbow 18, and an elongated horizontal tine 19. The backrest 17 is permanently affixed to the carriage 15, and has a thickness which protrudes slightly forward of the carriage back. The forks 16 are especially applicable for collecting building materials, such as sheet rock and wallboard, stacked in a unit load on a wood pallet or other standard support. In existing prior art vehicles, the protruding thickness of the vertical backrest 17 is a common source of damage to materials during loading and transport—particularly materials with relatively fragile edges, such as sheet rock and wallboard. Even slight to moderate damage caused to an edge during handling can render the entire product unfit for commercial sale.

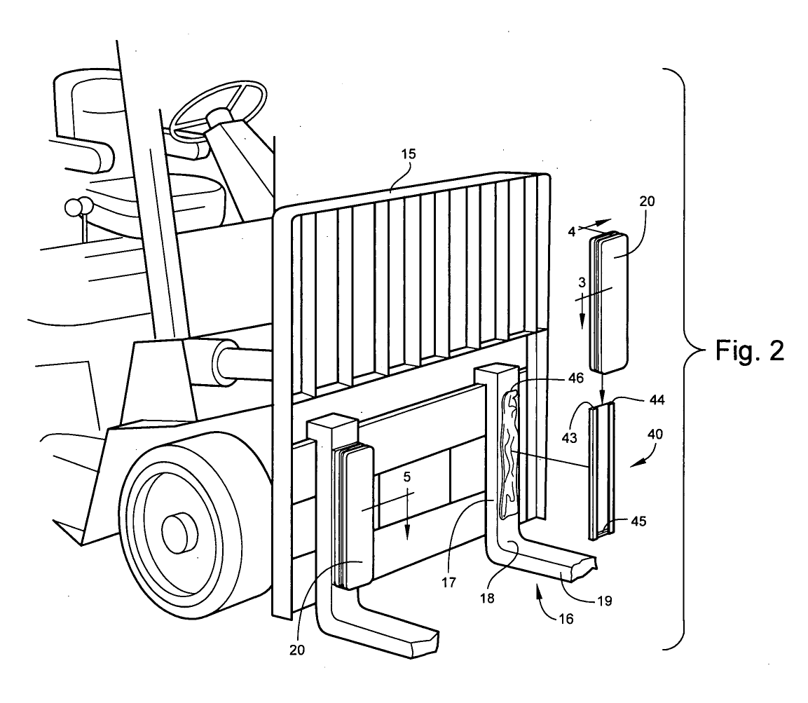

To address this issue, the present materials handling vehicle utilizes a pair of protective bumpers 20 located on the vertical backrest 17 of each fork 16. As shown in FIGS. 1, 1A, and 2, each bumper 20 is positioned a spaced distance above the horizontal tine 19 of the mechanical lift 11. This distance defines a bumper clearance sufficient to accommodate the height of the pallet or other support used for carrying the stacked materials. The clearance is preferably between 4-6 inches. When loading the materials, the back edge of the pallet can safely butt against each fork 16 adjacent respective elbows 18, and without contacting or damaging the protective bumper 20.

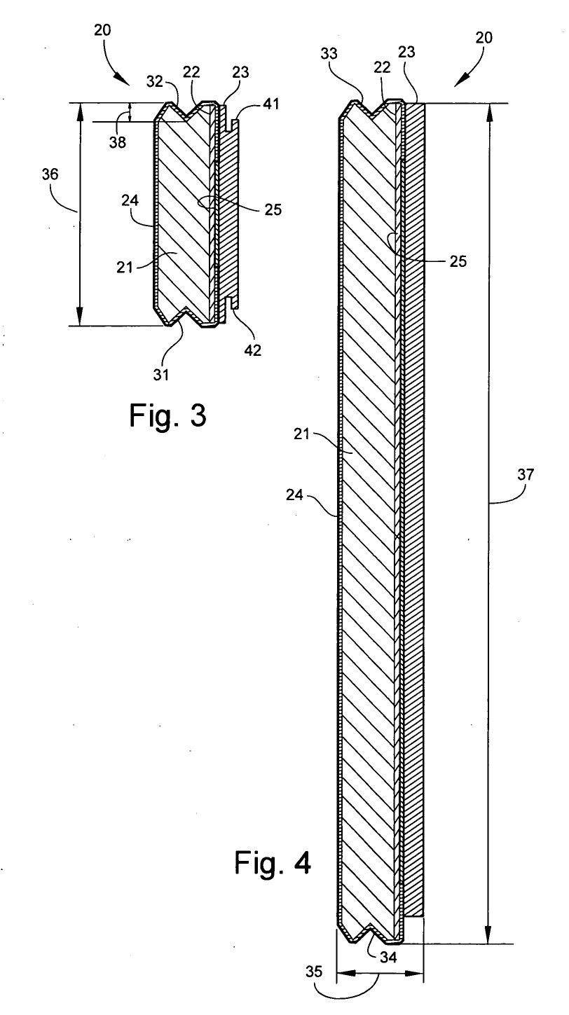

Referring to FIGS. 2, 3, and 4, the protective bumper 20 comprises a compressible resilient foam body 21, an inside base panel 22 attached to the foam body 21, an outside base panel 23 attached to the inside panel 22, and a flexible outer shell 24 covering the foam body 21 and sandwiched along its marginal edges between the inside and outside base panels 22, 23. The marginal edges of the outer shell 24 are preferably fused together with a polymer adhesive 25 between the inside and outside base panels 22, 23. Rivets or other fasteners (not shown) may also be used to further secure the outside base panel 23 to the inside panel 22 and foam body 21.

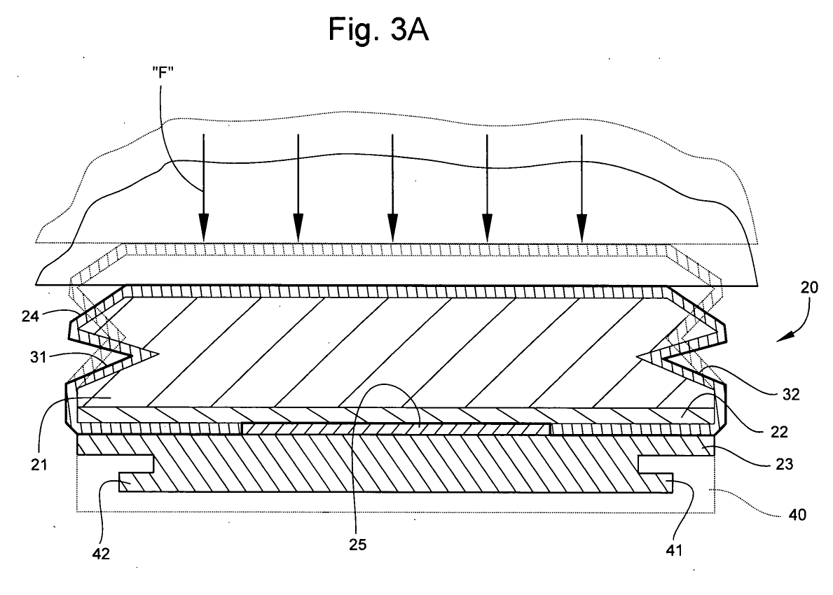

To increase impact resistance and the useful life of the protective bumper, compression pleats 31, 32, 33, and 34 are formed along opposing sides and ends of the outer shell 24 and foam body 21. Preferably, the compression pleats 31-34 extend in a continuous, uninterrupted path along an entire perimeter of the body 21. Upon impact of force “F”, as demonstrated in FIG. 3A, the protective bumper 20 compresses at respective folds defined by the pleats 31-34. The compression pleats 31-34 cooperate to help preserve the structure and resiliency of the bumper 20 over an extended period of usage.

According to one embodiment, the outer shell 24 is a vacuum formed, durable, low density polyethylene. The foam body 21 is constructed of low density closed cell foam, such as EPERAN® manufactured by the Kaneka Corporation. The foam body 21 is cut to shape and inserted into the outer shell 24. An ABS or other suitable adhesive permanently joins the foam body and outer shell together. The thickness 35 of the protective bumper 20 as measured from the front face to the outside base panel is preferably between 1-5 inches, and more preferably, approximately 2.5 inches. The width 36 of the protective bumper 20 is preferably between 4-6 inches, and the length 37 between 12-24 inches depending on the size of the fork 16. The depth 38 of each fold defined by the compression pleats 31-34 is approximately 0.75 inches.

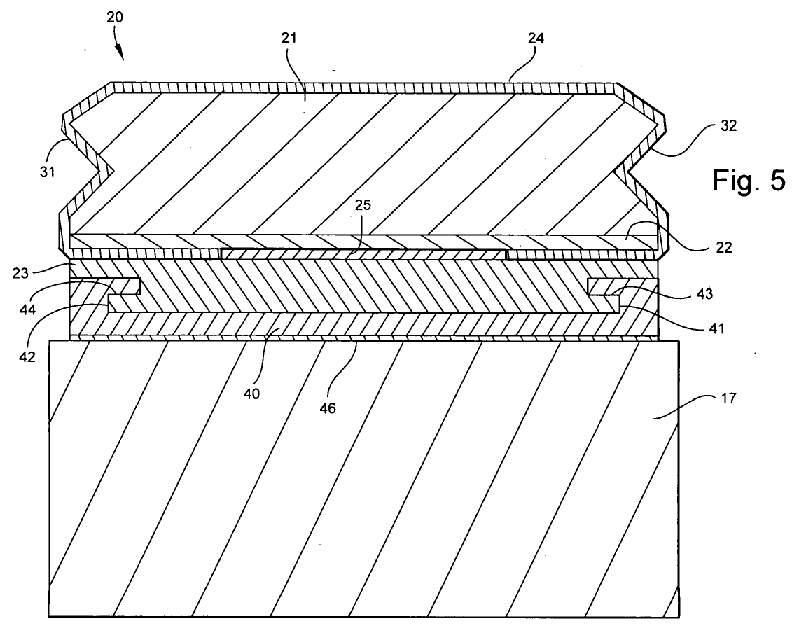

To enable convenient exchange and replacement, the protective bumper 20 is preferably removably attached to a mounting panel 40 permanently affixed to the fork backrest 17. As shown in FIGS. 2, 3A, and 5, the outside base panel 23 of the protective bumper 20 has opposing longitudinal track flanges 41 and 42 designed for locating within complementary longitudinal tracks 43 and 44 formed with the mounting panel 40. A lateral stop 45, shown in FIG. 2, is formed at the bottom of the mounting panel 40 to limit downward sliding movement of the protective bumper 20 upon its application to the vehicle 10. According to one embodiment, the mounting panel 40 is affixed to the fork backrest 17 using a suitable contact adhesive 46.

A protective bumper for a materials handling vehicle is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

We claim:

1. In a materials handling vehicle comprising a mechanical lift, the mechanical lift including a horizontal extension and a vertical back, a protective bumper designed for engaging and protecting materials carried by said vehicle, said protective bumper comprising:
a base located on the vertical back of the lift;
an elongated, compressible, resilient foam body adjacent said base; and
said foam body defining opposing longitudinal compression pleats and opposing lateral compression pleats, wherein said compression pleats defined by said foam body extend in a continuous uninterrupted path along an entire perimeter of said foam body.

2. A materials handling vehicle according to claim 1, wherein said protective bumper further comprises a flexible outer shell covering said resilient body.

3. A materials handling vehicle according to claim 2, wherein the outer shell of said protective bumper comprises polyethylene.

4. A materials handling vehicle according to claim 1, and comprising a mounting panel fixedly attached to the vertical back of the lift and engaging the base of said protective bumper.

5. A materials handling vehicle according to claim 4, wherein said mounting panel comprises opposing longitudinal side tracks.

6. A materials handling vehicle according to claim 5, wherein the base of said protective bumper comprises opposing longitudinal side edges adapted for being slidably received within respective side tracks of said mounting panel.

7. A materials handling vehicle according to claim 6, wherein said mounting panel comprises a bottom end stop adapted for limiting downward sliding movement of said protective bumper.

8. A materials handling vehicle according to claim 1, wherein the resilient body of said protective bumper has a generally uniform thickness ranging from 1 to 3 inches.

9. A materials handling vehicle according to claim 1, wherein the horizontal extension of said mechanical lift comprises a pair of laterally spaced fork tines.

10. A materials handling vehicle according to claim 1, wherein said protective bumper is vertically spaced-apart from said horizontal extension, thereby defining a bumper clearance sufficient to accommodate a materials support platform between said horizontal extension and said protective bumper.

11. A protective bumper designed for engaging and protecting materials carried by a materials handling vehicle, said protective bumper comprising:
a base; and
an elongated, compressible, resilient foam body adjacent said base; and
said foam body defining opposing longitudinal compression pleats and opposing lateral compression pleats, wherein said compression pleats defined by said foam body extend in a continuous uninterrupted path along an entire perimeter of said foam body.

12. A protective bumper according to claim 11, and comprising a flexible outer shell covering said resilient body.

13. A protective bumper according to claim 12, wherein said outer shell comprises polyethylene.

14. A protective bumper to claim 11, wherein said resilient body has a generally uniform thickness ranging from 1 to 3 inches.
